(19) United States
(12) Patent Application Publication
(10) Pub. No.: US 2005/0225042 A1
(43) Pub. Date: Oct. 13, 2005

(54) Snow board having adjustable handle

(76) Inventor: Tsung Yuan Liu, Chang Hua (TW)

Correspondence Address: CHARLES E. BAXLEY, ESQ., 90 JOHN STREET, THIRD FLOOR, NEW YORK, NY, 10038, US

(21) Appl. No.: 10/819,521

(22) Filed: Apr. 6, 2004

(51) Int. Cl. B62B 9/04

(52) U.S. Cl. 280/14.21

(57) ABSTRACT

A snow board includes a board member, a bracket to support a handle and having a number of holes for receiving fasteners which may secure the bracket to the board member, to adjustably secure the bracket and the handle to the board member at different locations, according to such as different heights of different users, for allowing the snow board to be suitably used or operated by various users. The board member includes a number of orifices formed in two rows for aligning with the holes of the bracket, and for receiving the fasteners, and a number of lock members engaged in the orifices for threading with the fasteners.

### BACKGROUND OF THE INVENTION

1. Field of the Invention

The present invention relates to a snow board, and more particularly to a snow board having an adjustable handle adjustable to different locations relative to the snow board.

2. Description of the Prior Art

Various kinds of typical snow boards have been developed and comprise an elongate board member having one end bent upwardly. For example, U.S. Pat. No. 6,105,991 to Dodge et al. discloses one of the typical snow boards. However, the typical snow boards do not include any handle devices attached thereto, such that the typical snow boards are not good for beginners.

U.S. Pat. No. 5,967,542 to Williams et al. discloses another typical snow board having snowboard bindings disposed above the snowboard, for attaching the snow boots to the snowboard. Similarly, the typical snow boards also do not include any handle devices attached thereto, such that the typical snow boards are also not good for beginners.

U.S. Pat. No. 6,139,031 to Wingard discloses a further typical snow board having a steering handle or a control handle extended upwardly from the snowboard, for supporting the upper portions of the users, such that the typical snow board is good for the beginners. However, the steering handle or the control handle is upwardly extended from the snowboard, and may not be adjusted to different locations relative to the snow board, such that the typical snow board may not be suitably used or operated by various users of different heights or weights the like.

The present invention has arisen to mitigate and/or obviate the afore-described disadvantages of the conventional snow boards.

### SUMMARY OF THE INVENTION

The primary objective of the present invention is to provide a snow board including an adjustable handle adjustable to different locations relative to the snow board, according to such as different heights of different users, for allowing the snow board to be suitably used or operated by various users.

In accordance with one aspect of the invention, there is provided a snow board comprising a board member, a bracket including a plurality of holes formed therein, a handle secured to the bracket, and a plurality of fasteners engaged through the holes of the bracket, and threaded to the board member, to adjustably secure the bracket and the handle to the board member at different locations, according to such as different heights of different users, for allowing the snow board to be suitably used or operated by various users.

The board member includes a plurality of orifices formed therein for aligning with the holes of the bracket, and for receiving the fasteners. The orifices of the board member are arranged in two rows. The board member further includes at least one aperture not aligned with the orifices of the board member.

The board member includes a plurality of lock members engaged in the orifices thereof and each having an inner thread formed therein for threading with the fasteners. The bracket includes at least one oblong slot formed therein, for slidably receiving the fasteners.

The bracket includes a barrel extended upwardly therefrom, to support the handle. The handle includes a stem adjustably secured thereon with a lock device.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a snow board in accordance with the present invention;

FIG. 2 is a partial exploded view of the snow board;

FIG. 3 is another partial exploded view of the snow board, illustrating orifices to be formed in different locations of the snow board;

FIG. 4 is a partial side view of the snow board;

FIG. 5 is a partial top view of the snow board, illustrating the operation of the snow board;

FIG. 6 is a partial side view similar to FIG. 4, illustrating the adjustment of the handle relative to the snow board;

FIG. 7 is a partial top view similar to FIG. 5, illustrating the adjustment of the handle relative to the snow board;

FIG. 8 is a partial exploded view similar to FIGS. 2 and 3, illustrating the other arrangement of the snow board;

FIGS. 9, 10, 11, 12 are partial top views illustrating the adjustment of the handle relative to the snow board as shown in FIG. 8;

FIG. 13 is a partial exploded view similar to FIGS. 2, 3 and 8, illustrating another arrangement of the snow board;

FIGS. 14, 15 are partial top views illustrating the adjustment of the handle relative to the snow board as shown in FIG. 13;

FIG. 16 is a partial exploded view similar to FIGS. 2, 3, 8 and 13, illustrating a further arrangement of the snow board;

FIGS. 17, 18 are partial top views illustrating the adjustment of the handle relative to the snow board as shown in FIG. 16;

FIG. 19 is a partial exploded view similar to FIGS. 2, 3, 8, 13, and 16, illustrating a still further arrangement of the snow board; and

FIGS. 20, 21, 22, 23 are partial top views illustrating the adjustment of the handle relative to the snow board as shown in FIG. 19.

### DETAILED DESCRIPTION OF THE PREFERRED EMBODIMENT

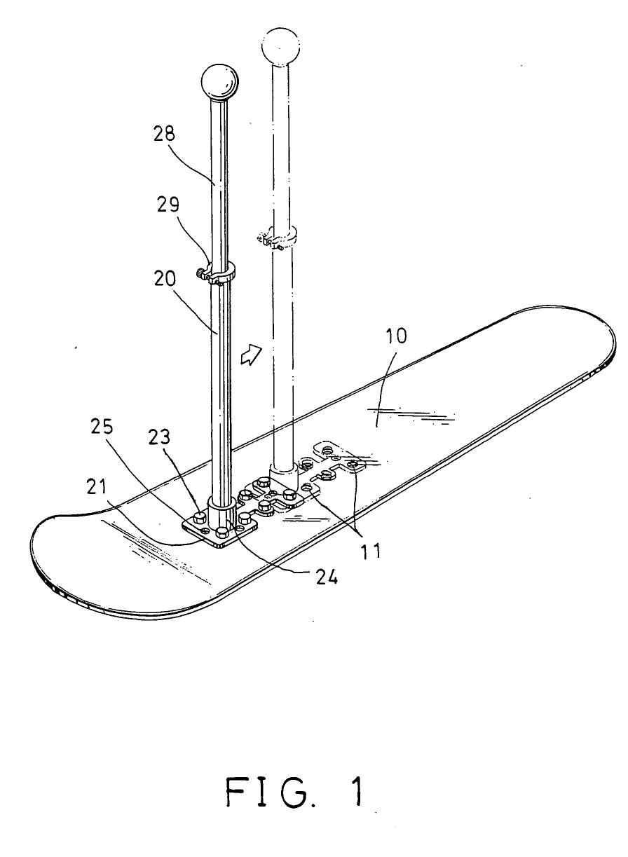

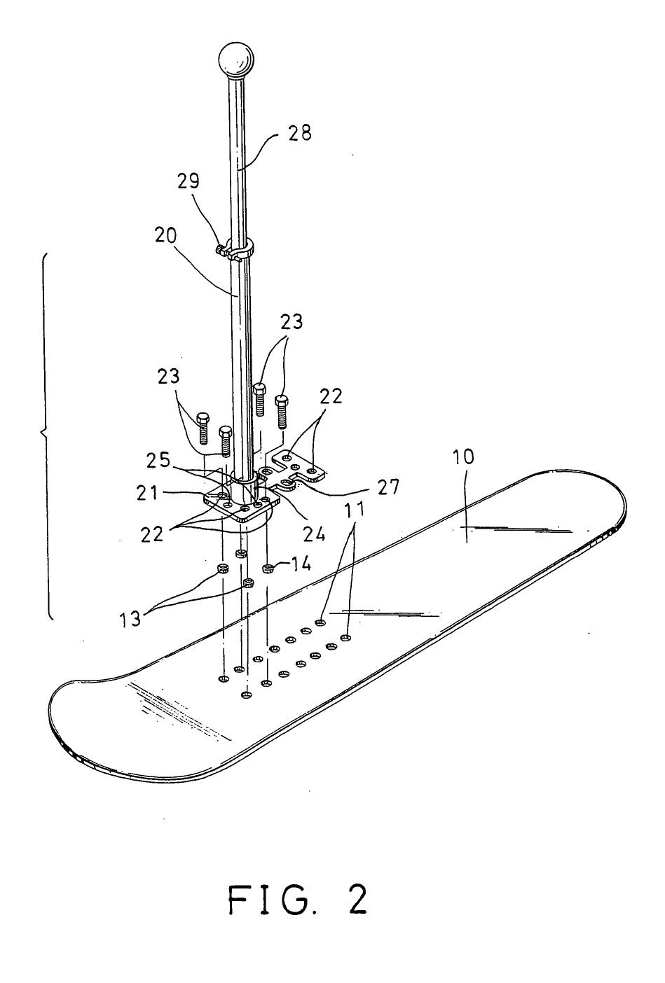

Referring to the drawings, and initially to FIGS. 1 and 2, a snow board in accordance with the present invention comprises a board member 10 including a number of orifices 11 formed therein and arranged in two rows, for example. The board member 10 may further include a number of apertures 12 formed therein and arranged between the two rows of orifices 11 thereof, or not aligned with the orifices 11 thereof.

The board member 10 may further include a number of lock members 13, such as lock nuts 13 engaged in the orifices 11 and the apertures 12 thereof and each having a screw hole or an inner thread 14 formed therein. The lock members 13 may be solidly received and engaged or embedded in the orifices 11 and the apertures 12 of the board member 10 while forming or molding the board member 10, for example.

A handle 20 is to be adjustably secured or attached to the board member 10, with such as a bracket 21. The bracket 21 may include a planar structure having two or more holes 22 formed therein for aligning with the orifices 11 of the board member 10 and for receiving fasteners 23 which may be threaded with the inner threads 14 of the lock members 13 for detachably securing the bracket 21 to the board member 10 (FIGS. 1, 2, 5).

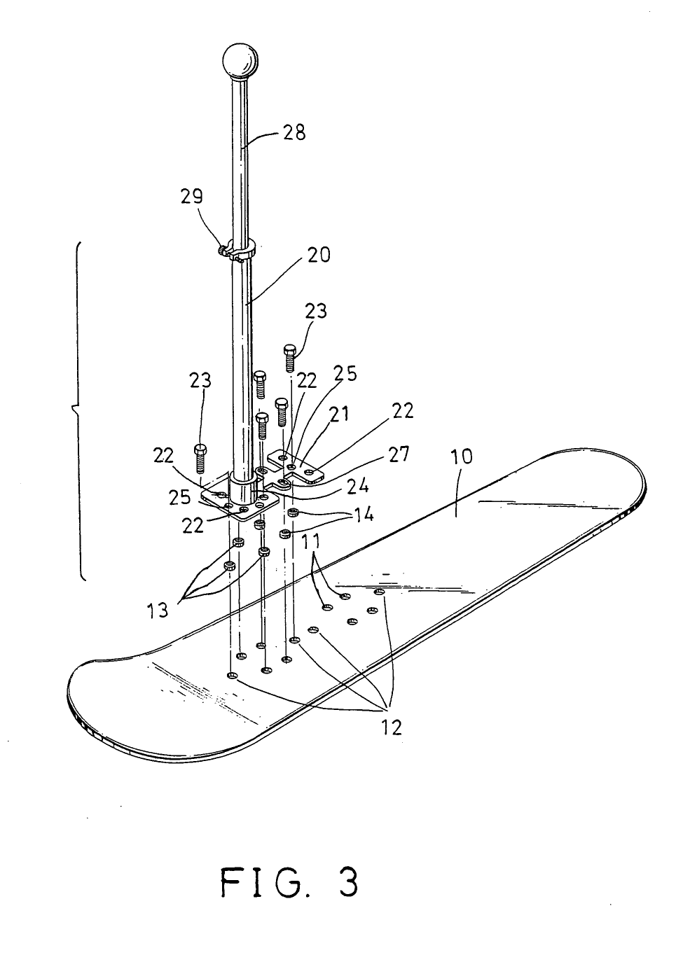

The bracket 21 includes a hub or a barrel 24 extended upwardly therefrom for receiving or securing the lower portion of the handle 20, and for allowing the handle 20 to be secured to the bracket 21. It is preferable that the bracket 21 further includes a number of cavities 25 formed therein, and arranged between the holes 22 of the bracket 21, or not aligned with or offset from the holes 22 of the bracket 21, for receiving the fasteners 23 which may also detachably secure the bracket 21 to the board member 10 (FIGS. 3, 6).

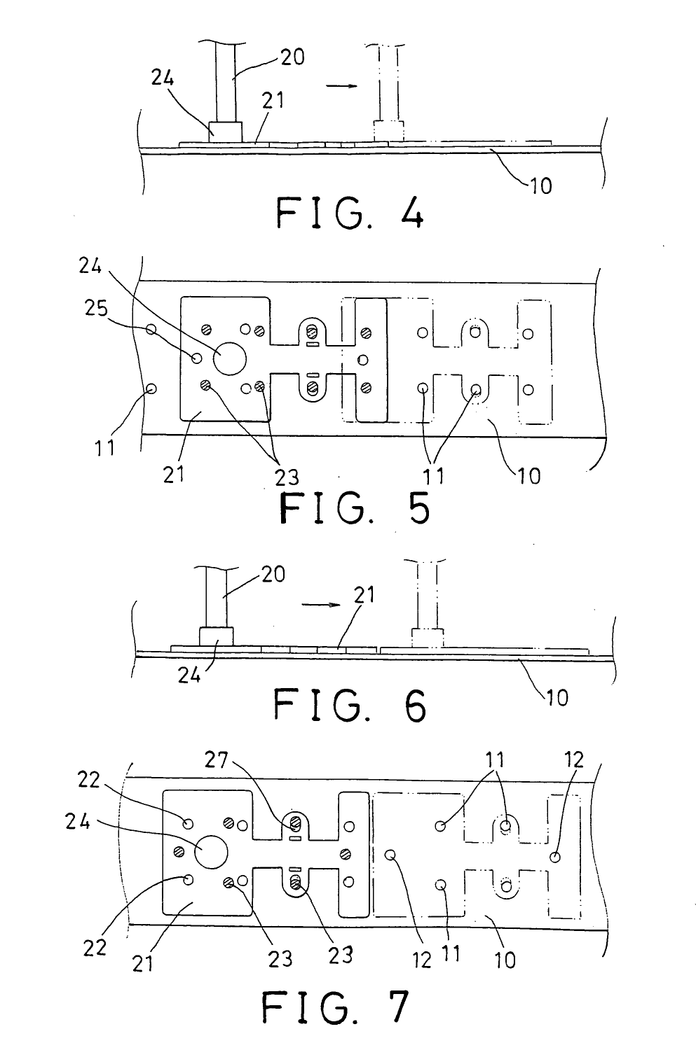

For example, the fasteners 23 may be engaged through the holes 22 of the bracket 21, and arranged in square or rectangular shapes or configurations, as shown in FIG. 5; or alternatively, arranged in triangular shapes or configurations, as shown in FIG. 7, for adjustably securing the bracket 21 to the board member 10 to different locations, as shown in solid lines and dotted lines in FIGS. 4 and 6.

It is preferable that the bracket 21 includes one or more oblong slots 27 formed therein, for slidably or adjustably receiving the fasteners 23, and for allowing the bracket 21 to be slightly adjusted relative to the board member 10 when the fasteners 23 are engaged through the oblong slots 27 of the bracket 21, and thus for allowing the bracket 21 and the handle 20 to be further adjusted relative to the board member 10 to different locations.

In operation, the bracket 21 and thus the handle 20 may be adjusted to different locations relative to the board member 10, according to the heights and/or the weights of different users.

The handle 20 may further include a stem 28 adjustably secured thereon with a quick release lock device 29, for allowing the handle 20 to be adjusted to different heights, to accommodate different users of different heights.

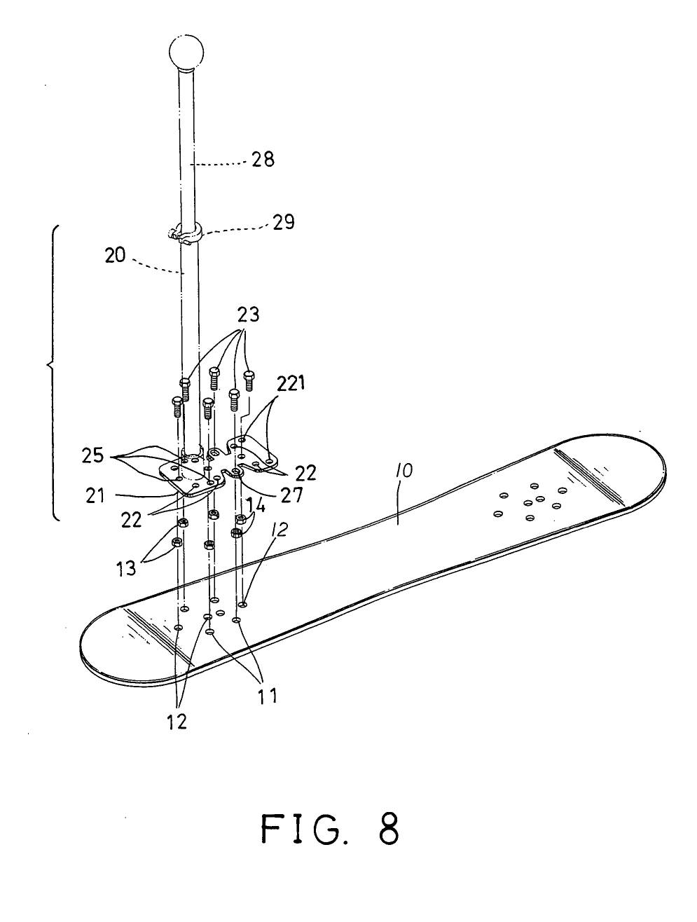

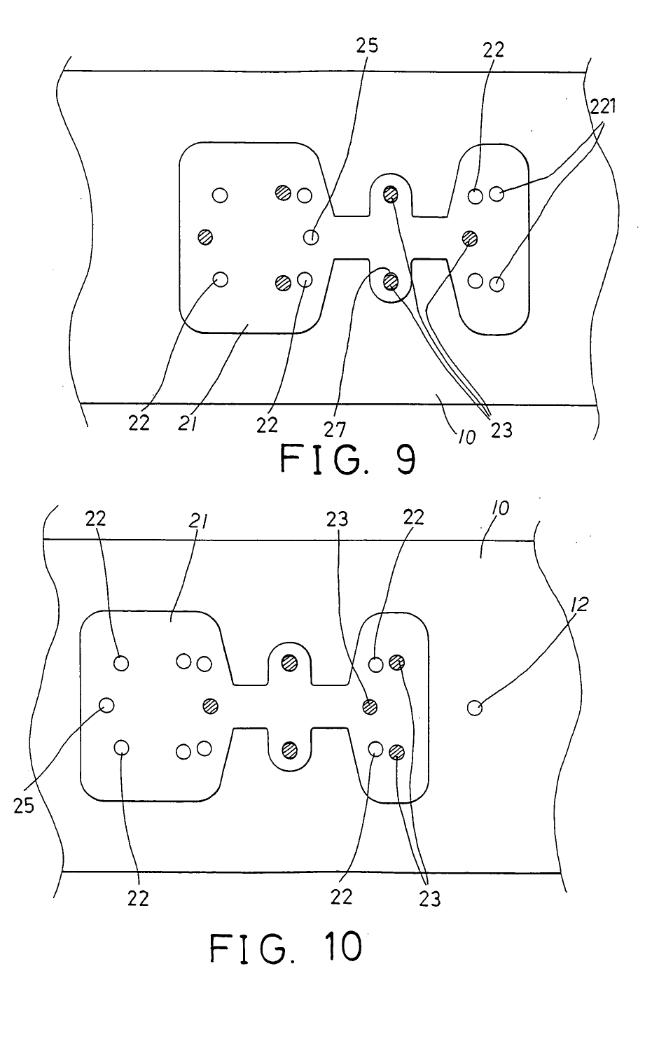

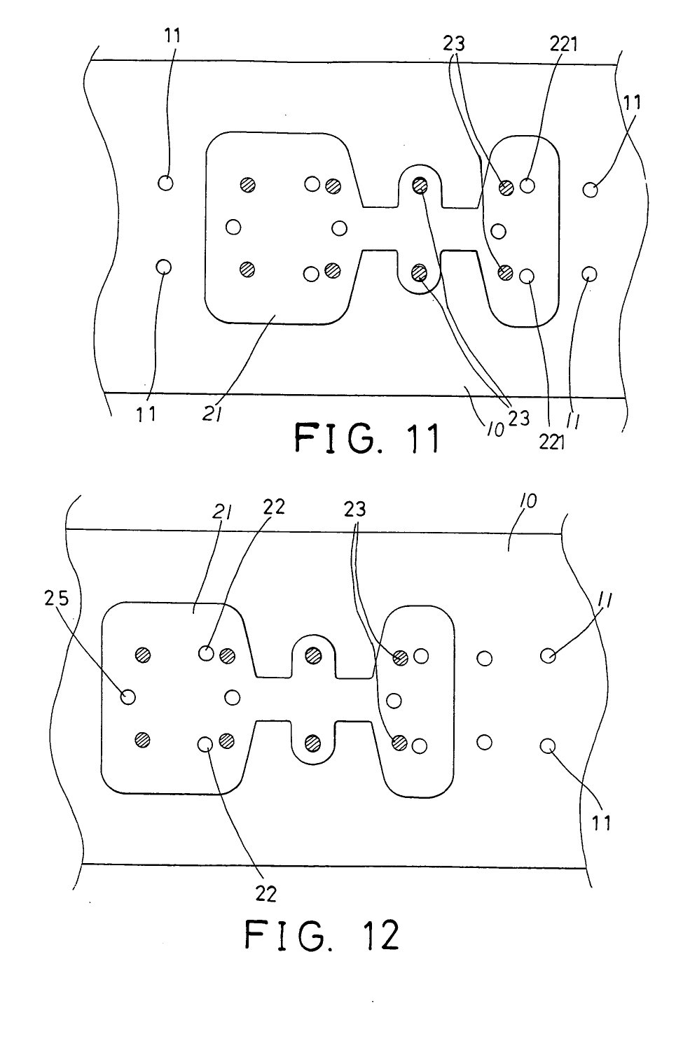

Referring next to FIGS. 8-12, the bracket 21 may include a longer length having one or more further holes 221 formed therein for aligning with the orifices 11 of the board member 10 and for receiving fasteners 23 which may be threaded with the inner threads 14 of the lock members 13 for further detachably or solidly securing the bracket 21 to the board member 10.

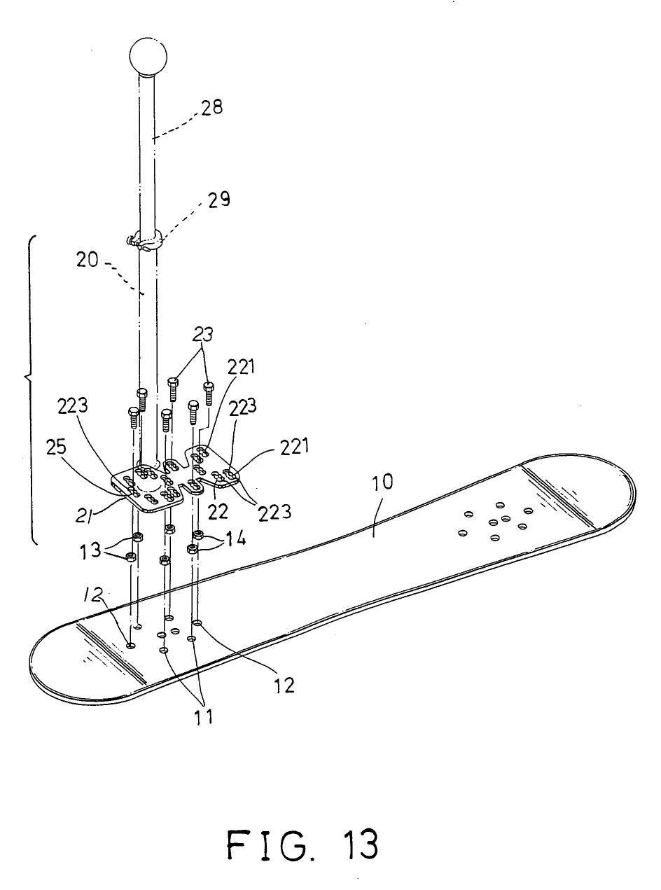

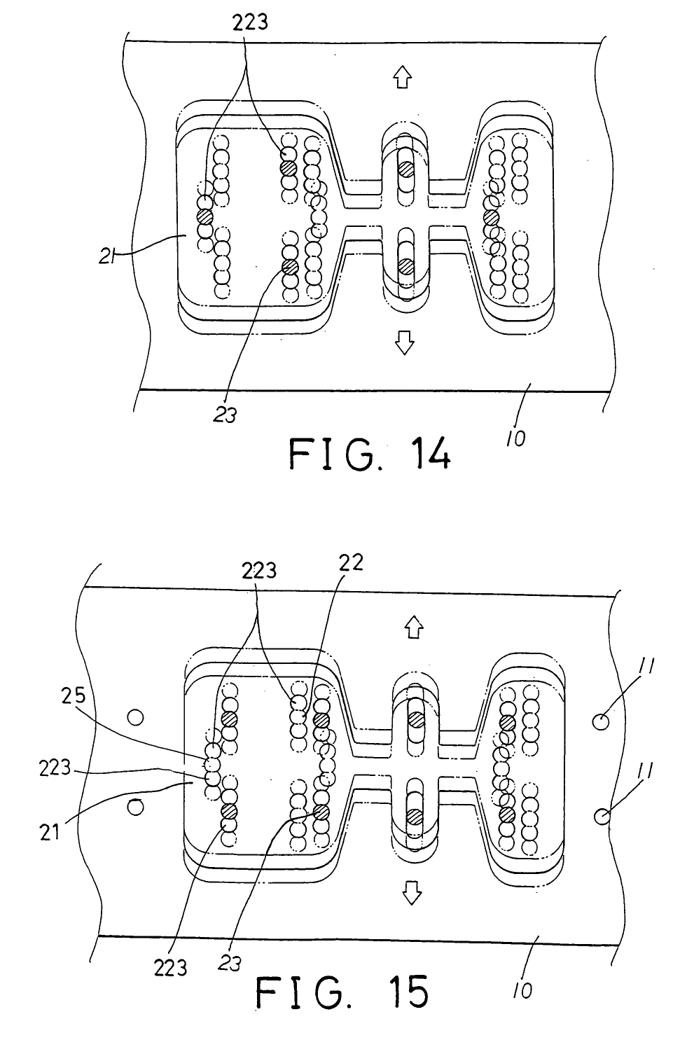

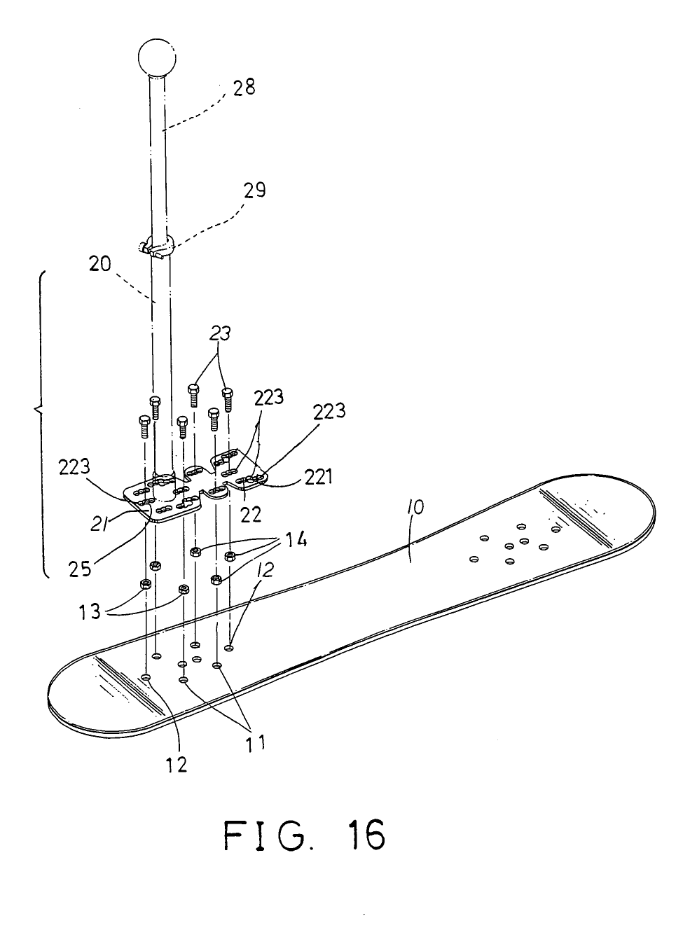

Referring next to FIGS. 13-15, the bracket 21 may further include one or more notches 223 formed therein, and formed beside and communicating with the holes 22, 221, and/or cavities 25, and/or oblong slots 27 thereof, for aligning with the orifices 11 and/or the apertures 12 of the board member 10 and for adjustably receiving fasteners 23 which may be threaded with the inner threads 14 of the lock members 13 for further detachably or adjustably securing the bracket 21 to the board member 10.

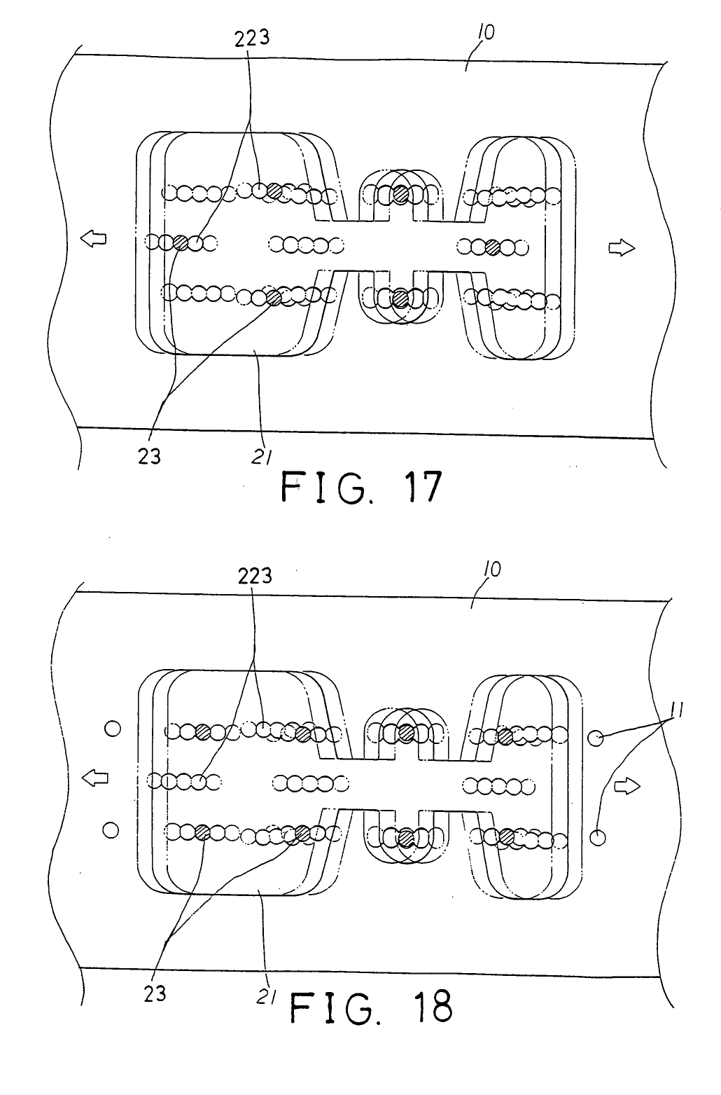

Referring next to FIGS. 16-18, the bracket 21 may further include one or more notches 223 formed therein, and formed in front of or behind and communicating with the holes 22, 221, and/or cavities 25, and/or oblong slots 27 thereof, for aligning with the orifices 11 and/or the apertures 12 of the board member 10 and for adjustably receiving fasteners 23 which may be threaded with the inner threads 14 of the lock members 13 for further detachably or adjustably securing the bracket 21 to the board member 10.

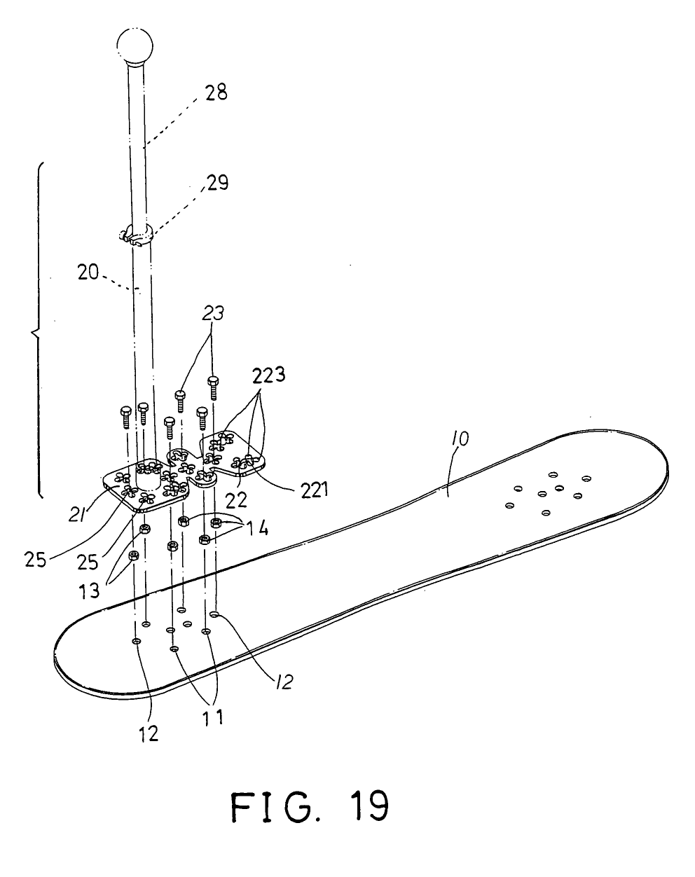

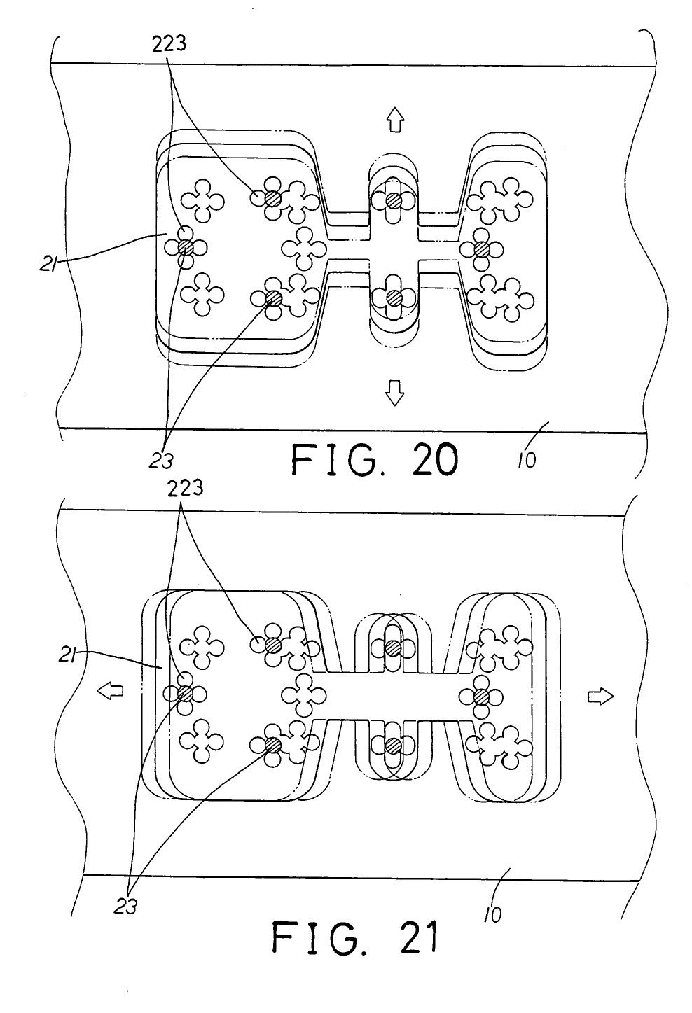

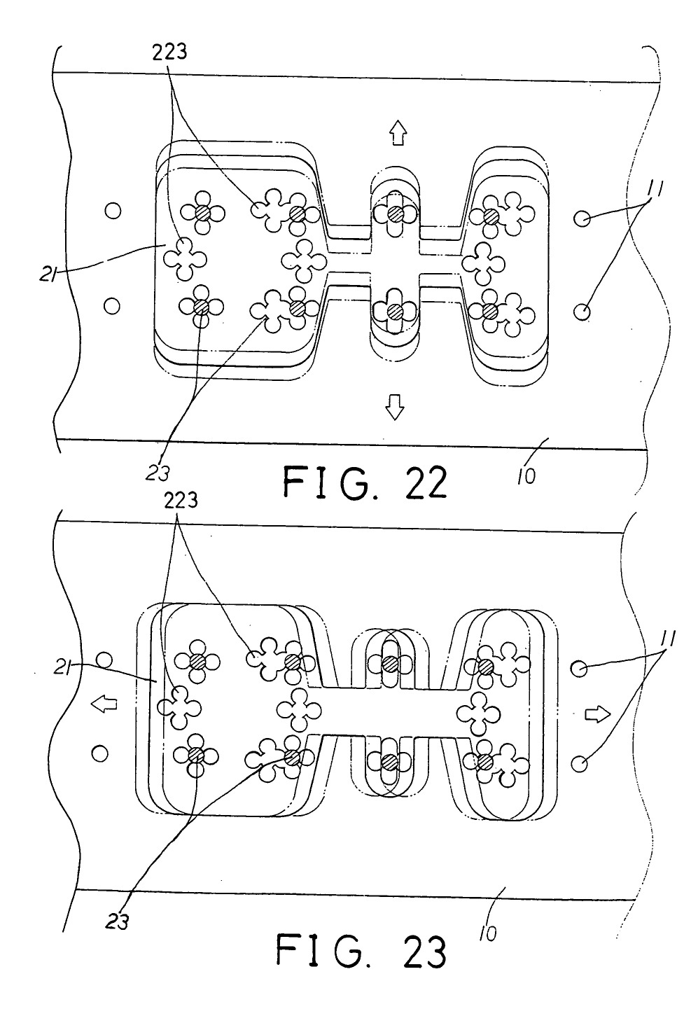

Referring next to FIGS. 19-23, the bracket 21 may further include one or more notches 223 formed therein, and formed in front of and/or behind and/or beside and communicating with the holes 22, 221, and/or cavities 25, and/or oblong slots 27 thereof, for aligning with the orifices 11 and/or the apertures 12 of the board member 10 and for adjustably receiving fasteners 23 which may be threaded with the inner threads 14 of the lock members 13 for further detachably or adjustably securing the bracket 21 to the board member 10.

Accordingly, the snow board in accordance with the present invention includes an adjustable handle adjustable to different locations relative to the snow board, according to such as different heights of different users, for allowing the snow board to be suitably used or operated by various users.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A snow board comprising:
a board member,
a bracket including a plurality of holes formed therein,
a handle secured to said bracket, and
a plurality of fasteners engaged through said holes of said bracket, and threaded to said board member, to adjustably secure said bracket and said handle to said board member at different locations.

2. The snow board as claimed in claim 1, wherein said board member includes a plurality of orifices formed therein for aligning with said holes of said bracket, and for receiving said fasteners.

3. The snow board as claimed in claim 2, wherein said orifices of said board member are arranged in two rows.

4. The snow board as claimed in claim 3, wherein said board member further includes at least one aperture not aligned with said orifices of said board member.

5. The snow board as claimed in claim 2, wherein said board member includes a plurality of lock members engaged in said orifices thereof and each having an inner thread formed therein for threading with said fasteners.

6. The snow board as claimed in claim 1, wherein said bracket includes at least one oblong slot formed therein, for slidably receiving said fasteners.

7. The snow board as claimed in claim 6, wherein said bracket further includes at least one notch formed therein and communicating with said at least one oblong slot thereof, for selectively receiving said fasteners.

8. The snow board as claimed in claim 1, wherein said bracket includes a plurality of cavities formed therein, and arranged between said holes of said bracket and offset from said holes of said bracket, for receiving said fasteners.

9. The snow board as claimed in claim 8, wherein said bracket further includes a plurality of notches formed therein and communicating with said cavities thereof, for selectively receiving said fasteners.

10. The snow board as claimed in claim 1, wherein said bracket includes a barrel extended upwardly therefrom, to support said handle.

11. The snow board as claimed in claim 1, wherein said handle includes a stem adjustably secured thereon with a lock device.

12. The snow board as claimed in claim 1, wherein said bracket further includes a plurality of notches formed therein and communicating with said holes thereof, for selectively receiving said fasteners.
